(19) United States
(12) Patent Application Publication
(10) Pub. No.: US 2024/0086755 A1
(43) Pub. Date: Mar. 14, 2024

(54) QUANTUM SERVICE MIGRATOR

(71) Applicant: Red Hat, Inc., Raleigh, NC (US)

(72) Inventors: Leigh Griffin, Waterford (IE); Stephen Coady, Waterford (IE)

(21) Appl. No.: 17/941,481

(22) Filed: Sep. 9, 2022

(51) Int. Cl. G06N 10/70; G06N 10/20

(52) U.S. Cl. CPC G06N 10/70; G06N 10/20

(57) ABSTRACT

Examples relating to transfer of quantum services among quantum computing devices in a quantum computing system are provided. In one example, a request to transfer a quantum service in a quantum computing system is received at a first quantum computing device. A second quantum computing device to which to transfer the quantum service is determined. The quantum service is paused at the first quantum computing device. A service replication for the quantum service is communicated from a first task manager service associated with the first quantum computing device to a second task manager service associated with the second quantum computing device.

### BACKGROUND

Quantum computing involves the use of quantum bits, referred to herein as “qubits,” which have characteristics that differ from those of classical (e.g., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit.

### SUMMARY

The examples disclosed herein relate to transferring quantum services among different quantum computing devices in a quantum computing system. In one example, a method includes receiving, by a first quantum computing device, a request to transfer a quantum service in a quantum computing system. The method includes determining, by the first quantum computing device, a second quantum computing device in the quantum computing system to which to transfer the quantum service. The method includes pausing, by the first quantum computing device, the quantum service in the first quantum computing device. The method includes communicating, by the first quantum computing device, a service replication for the quantum service from a first task manager service associated with the first quantum computing device to a second task manager service associated with the second quantum computing device.

In another example, a quantum computing device includes a memory and a quantum processor device coupled to the memory. The quantum processor device is to receive a service replication of a quantum service in a task manager service of the quantum computing device. The quantum processor device is to access a quantum service definition file associated with the quantum service. The quantum processor device is to configure one or more qubits based at least in part on the quantum service definition file.

In another example, a non-transitory computer-readable storage medium includes instructions configured to cause one or more processor devices, on a first quantum computing device that implements a plurality of qubits, to: determine a second quantum computing device in a quantum computing system to which to transfer a quantum service; pause the quantum service in a first task manager service associated with the first quantum computing device; communicate a service replication for the quantum service from a first task manager service associated with a first quantum computing device to a second task manager service associated with the second quantum computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 depicts a quantum computing system according to examples of the present disclosure.

FIG. 2 depicts metadata associated with a task manager service of a quantum computing device according to examples of the present disclosure.

FIG. 3 depicts a flow chart of a method according to examples of the present disclosure.

FIG. 4 depicts a flow chart of a method according to examples of the present disclosure.

FIG. 5 depicts a flow chart of a method according to examples of the present disclosure.

FIG. 6 depicts a system according to examples of the present disclosure.

FIG. 7 depicts a system according to examples of the present disclosure.

FIG. 8 depicts an example quantum computing device to implement examples according to the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Finally, it is noted that while, for purposes of illustration and simplicity, the certain aspects are illustrated as being implemented by quantum computing system that comprises a quantum computing device that in turn comprises a single quantum processor device, in practice the examples/implementations disclosed herein may be implemented in a quantum computing system that comprises any number of quantum computing devices, each of which may comprise one or more quantum processor devices. Thus, irrespective of the implementation, the examples/implementations may be implemented on a computer system that includes one or more quantum computing devices, wherein the one or more quantum computing devices comprise one or more quantum processor devices, and the one or more quantum processor devices implement functionality disclosed herein.

A quantum computing system may include a plurality of quantum computing devices that are spread geographically across multiple physical systems. Quantum services may access qubits and resources across the plurality of quantum computing devices (e.g., across the different physical systems) seamlessly (e.g., in a federated manner). However, it may be beneficial in some instances to execute a quantum service on a particular quantum computing device, such as a particular physical quantum hardware platform in the quantum computing system. For example, it may be desirable to co-locate execution of a quantum service at a certain quantum computing device with certain key resources. As another example, a quantum computing device executing a quantum service may be suffering from issues, such as heat, errors, failure, etc. It would be thus desirable to transfer the quantum service to a different quantum computing device in the quantum computing system.

Aspects of the present disclosure allow for the migration or transfer of quantum services among different quantum computing devices (e.g., hardware platforms) within a quantum system. For instance, in one example, a quantum computing device within a quantum computing system may include a service hardware migrator (SHM). The SHM may be in communication (e.g., via one or more application programming interfaces) with a task manager service of the quantum computing device. The SHM may also be in communication with, for instance, a database (e.g., repository) of quantum service definition files (e.g., quantum assembly (QASM) files).

The SHM may receive a request (e.g., from an operating system associated with the quantum computing device, from an operating system associated with the quantum computing system, or from a user) to migrate or transfer a quantum service to a different quantum computing device (e.g., a different hardware platform) within the overall quantum computing system. In response to the request, the SHM may access a quantum topology service (QTS) which has a quantum hardware map of the quantum computing system and quantum computing devices within the quantum computing system. The quantum hardware map may have details regarding parameters of the various quantum computing devices, such as their location, a route to the quantum computing devices, local properties of the quantum computing devices, services requiring registration (e.g., teleportation services), or other parameters.

In some examples, the SHM may determine the most appropriate quantum computing device within the quantum computing system based on the needs of the request and the quantum service. The quantum computing device determined by the SHM may be, for instance, a quantum computing device with a greater number of local qubits, a quantum computing device with a certain qubit type or having qubits with certain physical properties, a quantum computing device with low error or with a certain error correction scheme, a quantum computing device with more available qubit resources (e.g., a quiet quantum computing device that is currently using less qubit resources), or a quantum computing device located in a certain geographic location.

Once a destination quantum computing device is identified, the SHM of the transferring quantum computing device may identify the route to the destination quantum computing device. The SHM of the transferring quantum computing device may contact the SHM of the destination quantum computing device (e.g., a federated counterpart) and may provide data indicative of an intent to transfer a quantum service. The SHM at the transferring quantum computing device may contact its local task manager service, may pause the quantum service, and may communicate a service replication to the task manager service associated with the destination quantum computing device. For instance, in some examples, the task manager service of the transferring quantum computing device may set the task manager service of the destination quantum computing device as a destination target of the service replication request using the federated nature of the quantum computing system.

Upon receipt of the service replication in the local task manager service of the destination quantum computing device, the SHM of the destination quantum computing device may look for the service identifier of the quantum service in the task manager service. When the task manager indicates that the quantum service has started, the destination quantum computing device may locate the quantum service definition file associated with the service identifier and may begin the process of securing and/or configuring qubits for execution of the quantum service.

In some examples, the qubits may include local qubits associated with the destination quantum computing device. In some examples, the qubits may include previous qubits at the transferring quantum computing device. In some examples, the SHM at the destination quantum computing device may handle data restoration requests to read and/or write data from the qubits at the transferring quantum computing device to maintain quantum service functionality and provide for quantum service restoration.

Aspects of the present disclosure may provide technical effects and benefits. For instance, quantum services may be transferred among quantum computing devices within a quantum computing system through transfer of data among task manager services. The transferring of quantum services by service replication between task manager services may allow for execution of services at different quantum computing devices within a quantum computing system to leverage local conditions in a federated manner. The quantum services may be transferred among quantum computing devices in a quantum computing system such that the services are executed by quantum hardware that is more suitable for execution of the quantum service, leading to reduced errors and increased efficiency of the quantum computing system. The reduced errors and increased efficiency of the quantum computing system may increase coherence and availability of the quantum computational resources for the quantum computing system.

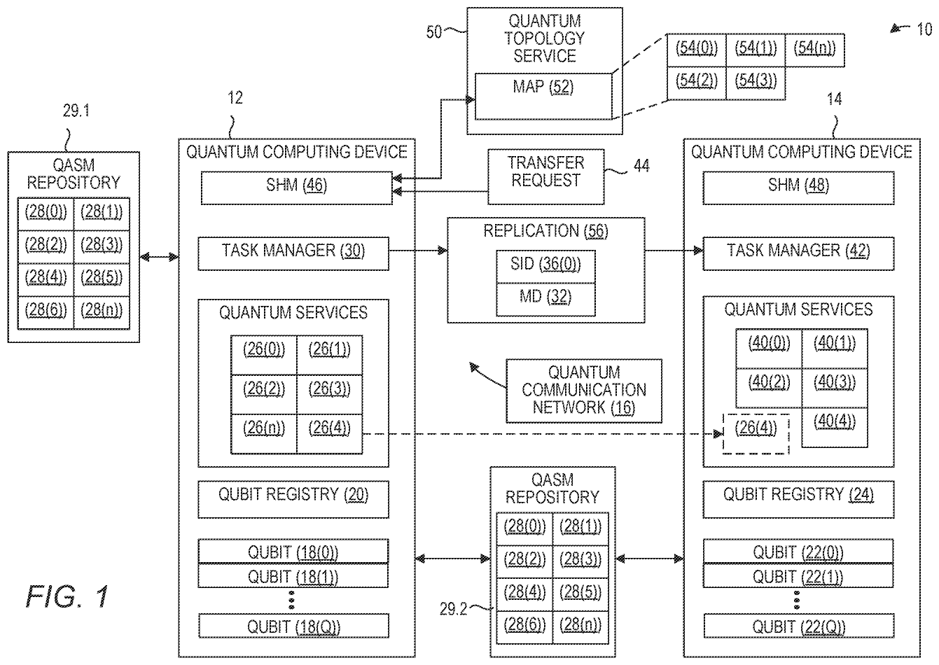

FIG. 1 depicts an example quantum computing system 10. The quantum computing system may include a first quantum computing device 12 and a second quantum computing device 14. The first quantum computing device 12 and the second quantum computing device 14 may be different hardware platforms for the quantum computing system 10. The first quantum computing device 12 and the second quantum computing device 14 may be in different geographic locations or in different areas within the same geographic location (e.g., different locations within the same building).

The first quantum computing device 12 and the second quantum computing device 14 may communicate with one another over a quantum communication network 16. The quantum communication network 16 may include quantum channels or other communication links for communication with one another and other devices, such as other quantum computing devices and/or classical computing devices. The quantum communication network 16 may include any number of wired and/or wireless communication links. The quantum computing system 10 may be provide a federated quantum computing system 10 with the first quantum computing device 12 and the second quantum computing device 14 being federated counterparts in the quantum computing system 10. In this way, quantum services may be transferred for local execution at the first quantum computing device 12 and the second quantum computing device 14 using local qubits and local data in a federated manner.

FIG. 1 illustrates a quantum computing system 10 with a first quantum computing device 12 and a second quantum computing device 14 for purposes of illustration and discussion. Those of ordinary skill in the art, using the disclosures provided herein, will understand that the quantum computing system 10 may include any number quantum computing devices without deviating from the scope of the present disclosure.

The first quantum computing device 12 operates in quantum environments but is capable of operating using classical computing principles or quantum computing principles. When using quantum computing principles, the first quantum computing device 12 performs computations that utilize quantum-mechanical phenomena, such as superposition and/or entanglement states. The first quantum computing device 12 may operate under certain environmental conditions, such as at or near zero degrees (0°) Kelvin. When using classical computing principles, the first quantum computing device 12 utilizes binary digits that have a value of either zero (0) or one (1).

In FIG. 1, the first quantum computing device 12 may use first qubits 18(0) . . . 18(Q), each of which has properties that differ from those of classical (e.g., non-quantum) bits used in classical computing. Each first qubit 18(0) . . . 18(Q) may encode quantum information for an underlying particle such as an atom or a photon and may possess characteristics that differ from those of classical (e.g., non-quantum) bits used in classical computing. For example, while a classical bit may be in a state of either one (1) or zero (0), each first qubit 18(0) . . . 18(Q) may be in a “superposition” of both states simultaneously. The first qubits 18(0) . . . 18(Q) may also experience a physical phenomenon referred to as “entanglement,” in which the quantum state of each first qubit 18(0) . . . 18(Q) may not be described independently of the state of another qubit. One application for the phenomenon of entanglement is quantum “teleportation” of a qubit. As used herein, teleportation refers to a process in which an entangled pair of qubits may be used to transmit quantum state information for a payload qubit (e.g., a qubit to be teleported) from one location to another, without having to transmit the payload qubit's underlying particle.

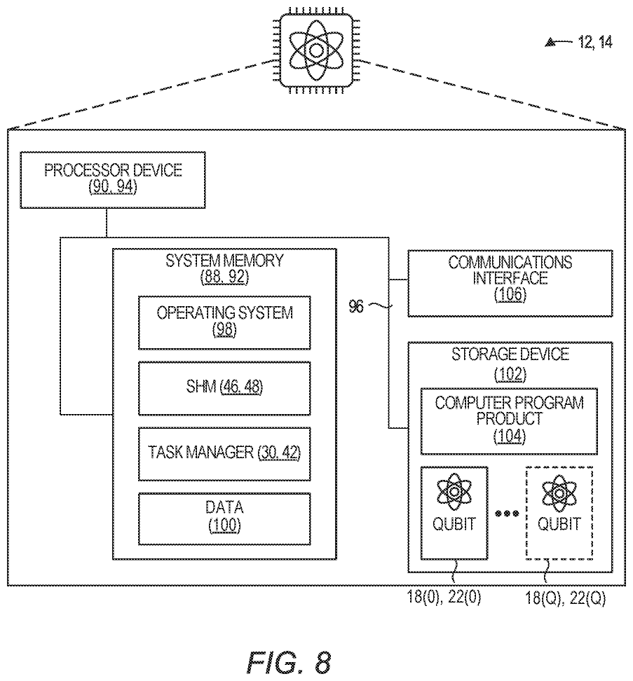

To maintain information for the first qubits 18(0) . . . 18(Q), the first quantum computing device 12 may include a first qubit registry 20. The first qubit registry 20 may include a plurality of qubit registry entries each corresponding to a qubit, such as one of first qubits 18(0) . . . 18(Q). The first qubit registry 20 maintains and provides access to data relating to the first qubits 18(0) . . . 18(Q) implemented by the first quantum computing device 12, such as a count of the total number of qubits implemented by the first quantum computing device 12 and a count of the number of available qubits that are currently available for allocation (“qubit resource allocation”), as non-limiting examples. Each of the entries of the first qubit registry 20 also stores qubit metadata for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an entanglement indicator that indicates whether the corresponding qubit is in an entangled state. Details concerning an example of the first quantum computing device 12 will be set forth with respect to FIG. 8.

Similar to the first quantum computing device 12, the second quantum computing device 14 operates in quantum environments but is capable of operating using classical computing principles or quantum computing principles. When using quantum computing principles, the second quantum computing device 14 performs computations that utilize quantum-mechanical phenomena, such as superposition and/or entanglement states. The second quantum computing device 14 may operate under certain environmental conditions, such as at or near zero degrees (0°) Kelvin. When using classical computing principles, the second quantum computing device 14 utilizes binary digits that have a value of either zero (0) or one (1).

In FIG. 1, the second quantum computing device 14 may use second qubits 22(0) . . . 22(Q), each of which has properties that differ from those of classical (e.g., non-quantum) bits used in classical computing. The second qubits 22(0) . . . 22(Q) may encode quantum information for an underlying particle such as an atom or a photon and may possess characteristics that differ from those of classical (e.g., non-quantum) bits used in classical computing. For example, the second qubits 22(0) . . . 22(Q) may be in a “superposition” of both 1 and 0 states simultaneously. The second qubits 22(0) . . . 22(Q) may also experience entanglement with other qubits and/or may be used for teleportation.

To maintain information for the second qubits 22(0) . . . 22(Q), the second quantum computing device 14 may include a second qubit registry 24. The second qubit registry 24 may include a plurality of qubit registry entries each corresponding to a qubit, such one of second qubits 22(0) . . . 22(Q). The second qubit registry 24 maintains and provides access to data relating to the second qubits 22(0) . . . 22(Q) implemented by the second quantum computing device 14, such as a count of the total number of qubits implemented by the second quantum computing device 14 and qubit resource allocation, as non-limiting examples. Each of the qubit registry entries of the second qubit registry 24 also stores qubit metadata for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an entanglement indicator that indicates whether the corresponding qubit is in an entangled state. Details concerning an example of the second quantum computing device 14 will be set forth with respect to FIG. 8.

The first quantum computing device 12 may execute a plurality of quantum services 26(0) . . . 26(n). A quantum service is a process or set of processes that employs qubits (e.g., the first qubits 18(0) . . . 18(Q)) to provide desired functionality.

Each quantum service 26(0) . . . 26(n) may be associated with an operation or set of operations. The operations may identify qubits, preconfigure qubits, instantiate qubits, place them into specific quantum states and relationships, store values using the qubits, and/or subsequently deallocate and reuse the qubits to return a result for the quantum service. In some examples, a quantum service 26(0), 26(1), . . . 26(n) may place one or more qubits in a state of superposition, may place one or more qubits in a state of entanglement of one or more other qubits, and/or provide teleportation of data between qubits.

FIG. 1 depicts six quantum services 26(0), . . . 26(n) for purposes of illustration and discussion. Those of ordinary skill in the art, using the disclosures provided herein will understand that the first quantum computing system 12 may implement tens, hundreds or even thousands of quantum services 26(0), . . . 26(n).

Each quantum service 26(0), . . . 26(n) may be defined by one of a plurality of quantum service definition files 28(0), . . . 28(n). For instance, the quantum service 26(4) may be defined by the quantum service definition file 28(4). The quantum service definition file 28(0), . . . 28(n) may have a plurality of quantum programming instructions for allocating and manipulating qubits to achieve a desired functionality associated with the quantum service 26(0), . . . 26(n). The quantum service definition file 28(0), . . . 28(n) in some examples may include a QASM file, as a non-limiting example.

The quantum service definition files 28(0), . . . 28(n) may be stored in a memory, such as QASM repository 29.1 and/or QASM repository 29.2. The memory may be a dedicated memory accessible by the first quantum computing device 12, such as QASM repository 29.1. The memory may be a shared memory for the quantum computing system 10 accessible by the first quantum computing device 12, the second quantum computing device 14, and/or other quantum computing devices in the quantum computing system 10, such as QASM repository 29.2.

The first quantum computing device 12 may implement a first task manager service 30. The first task manager service 30 may collect data regarding the first quantum computing device 12 and/or the quantum services 26(0), . . . 26(n) that may be implemented on the first quantum computing device 12. The first task manager service 30 may provide such data upon request to other services executing on the first quantum computing device 12 and/or the quantum computing system 10 (e.g., to a scheduling service and/or to an operating system). The first task manager service 30 may, for instance, collect and maintain metadata regarding the services 26(0), . . . 26(n), the state of the qubits (e.g., as obtained from the first qubit registry 20), and/or the first quantum computing device 12 (e.g., a current temperature of the first quantum computing device 12, coherence information, gate error information, etc.) using one or more application program interfaces.

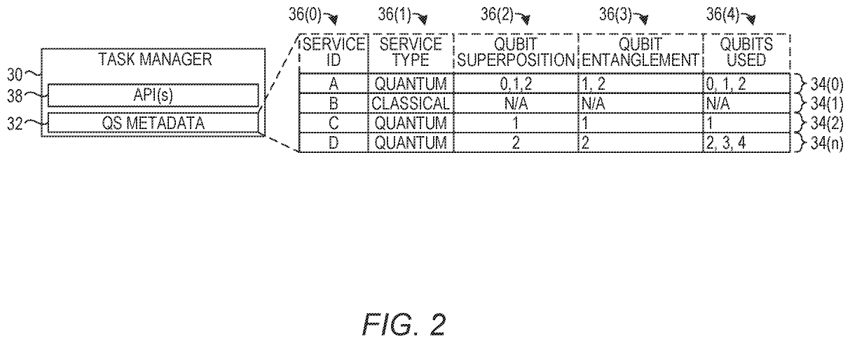

FIG. 2 is a block diagram illustrating aspects of the first task manager service 30. The first task manager service 30 collects and obtains metadata 32. In this example, the metadata 32 includes rows 34(0) . . . 34(n) that each correspond to a quantum service 26(0) . . . 26(n) that may be implemented in the first quantum computing system 12 and that contains data about the corresponding quantum service 26(0) . . . 26(n). Four rows are depicted in FIG. 2 for ease of illustration. Those of ordinary skill in the art, using the disclosures provided herein, will understand that the metadata 32 may include multiple rows, one corresponding to each quantum service 26(0) . . . 26(n).

Each row 34(0) . . . 34(n) may include a plurality of fields associated with different aspects of metadata 32 for a quantum service. FIG. 2 depicts 5 example fields. The metadata 32 may include other fields without deviating from the scope of the present disclosure. In the example of FIG. 2, the metadata 32 may include a service identifier field 36(0) for a unique service identifier that identifies the quantum service 26(0) . . . 26(n). The metadata 32 may include a service type field 36(1) for data indicative of service type that identifies the type of quantum service 26(0) . . . 26(n). The type may be, for example, a quantum computing type that indicates that the quantum service 26(0) . . . 26(n) utilizes quantum computing and may also utilize classical computing or may be a classical computing type that indicates that the quantum service 26(0) . . . 26(n) utilizes only classical computing. The metadata 32 may include a superposition status field 36(2) that identifies those first qubits 18(0), . . . 18(Q), if any, that are in a state of superposition. The metadata 32 may include an entanglement status field 36(3) that identifies those first qubits 18(0), . . . 18(Q), if any, that are in a state of entanglement. The metadata may include a qubit identifier field 36(4) that identifies the subset of the first qubits 18(0), . . . 18(Q), if any, that are used by the corresponding quantum service 26(0) . . . 26(n).

The first task manager service 30 may provide and/or obtain some or all the information maintained in the metadata 32 via one or more application programming interfaces 38. For instance, the first task manager service 30 may obtain information maintained in the metadata 32 from, for instance, the first qubit registry 20, the quantum services 26(0) . . . 26(n), the QASM repository 29.1, the QASM repository 29.1, an operating system associated with the quantum computing device 12 and/or the quantum computing system 10, or another suitable source.

FIG. 2 depicts on example structure for metadata 32 (e.g., a table). Any suitable structure may be used for metadata without deviating from the scope of the present disclosure.

Referring to FIG. 1, the second quantum computing device 14 may execute a plurality of quantum services 40(0) . . . 40(n) that employs qubits (e.g., the second qubits 22(0) . . . 22(Q)) to provide desired functionality. Each quantum service 40(0) . . . 40(n) may be associated with an operation or set of operations. The operations may identify qubits, preconfigure qubits, instantiate qubits, place them into specific quantum states and relationships, store values using the qubits, and/or subsequently deallocate and reuse the qubits to return a result for the quantum service. In some examples, a quantum service 40(0) . . . 40(n) may place one or more qubits in a state of superposition, may place one or more qubits in a state of entanglement of one or more other qubits, and/or provide teleportation of data between qubits.

FIG. 1 depicts six quantum services 40(0), . . . 40(n) for purposes of illustration and discussion. Those of ordinary skill in the art, using the disclosures provided herein will understand that the second quantum computing device 14 may implement tens, hundreds or even thousands of quantum services 40(0) . . . 40(n).

Each quantum service 40(0), . . . 40(n) may be defined by one of a plurality of quantum service definition files 28(0), . . . 28(n). The quantum service definition file 28(0), . . . 28(n) may have a plurality of quantum programming instructions for allocating and manipulating qubits to achieve a desired functionality associated with the quantum service 40(0), . . . 40(n). The quantum service definition file 28(0), . . . 28(n) in some examples may comprise a Quantum Assembly File (QASM) file, as a non-limiting example.

The quantum service definition files 28(0), . . . 28(n) may be stored in a memory, such as QASM repository 29.1 and/or QASM repository 29.2. The memory may be a dedicated memory (not shown) accessible by the second quantum computing device 14. The memory may be a shared memory for the quantum computing system 10 accessible by the first quantum computing device 12, the second quantum computing device 14, and/or other quantum computing devices in the quantum computing system 10, such as QASM repository 29.2.

The second quantum computing device 14 may implement a second task manager service 42. The second task manager service 42 may collect data regarding the second quantum computing device 14 and/or the quantum services 40(0), . . . 40(n) that may be implemented on the second quantum computing device 14. The second task manager service 42 may provide such data upon request to other services executing on the second quantum computing device 14 and/or the quantum computing system 10 (e.g., to a scheduling service and/or to an operating system). The second task manager service 40 may, for instance, collect and maintain metadata regarding the quantum services 40(0) . . . 40(n), the state of the qubits (e.g., as obtained from the second qubit registry 24), and/or the second quantum computing device 14 (e.g., a current temperature of the second quantum computing device 14, coherence information, gate error information, etc.). The second task manager service 40 may have aspects similar to the first task manager service 30 discussed with reference to FIG. 2.

Referring to FIG. 1, according to aspects of the present disclosure, the first quantum computing device 12 may receive a request to transfer (“transfer request”) 44 to transfer one of the quantum services 26(0) . . . 26(n) for execution at a different quantum computing device, such as the second quantum computing device 14. The transfer request 44 may come, for instance, from an operating system, scheduler service, or other service of the quantum computing system 10 (e.g., via an application programming interface). The transfer request 44 may come from a user of the quantum computing system 10 (e.g., via a user interface).

The first quantum computing device 12 may include a service hardware migrator (SHM) 46. The second quantum computing device 14 may include an SHM 48. The SHM 46, 48 may manage the transfer of services between quantum computing devices in the quantum computing system 10. The SHM 46, 48 may be in communication (e.g., via one or more application programming interfaces) with task manager service(s) implemented by quantum computing devices in the quantum computing system, such as the first task manager service 30 and/or the second task manager service 42. The SHM 46, 48 may also be in communication with, for instance, a database (e.g., repository) of quantum service definition files (e.g., quantum assembly (QASM) files), such as the QASM repository 29.1 and/or the QASM repository 29.2.

Referring to FIG. 1, because SHM 46, 48 is a component of the first quantum computing device 12 and the second quantum computing device 14 respectively, functionality implemented by the SHM 46, 48 may be attributed to either the first quantum computing device 12 or the second quantum computing device 14 respectively. Moreover, in examples where the SHM 46, 48 comprises software instructions that program a processor device (e.g., a quantum processor device) to carry out functionality discussed herein; functionality implemented by the SHM 46, 48 may be attributed herein to the processor device (e.g., a quantum processor device). The same is true for any of the quantum services or other services implemented by the first quantum computing device 12 (e.g., the first task manager service 30) or the second quantum computing device 14 (e.g., the second task manager service 40).

It is further noted that while the SHM 46, 48 is shown as a single component on each of the first quantum computing device 12 and the second quantum computing device 14 respectively, in other implementations, the SHM 46, 48 may be implemented in a plurality of components. Finally, it is noted that while, for purposes of illustration and simplicity, the examples are illustrated as being implemented by a single quantum processor device on a single quantum computing device, in other environments, such as a distributed and/or clustered environment, and where the SHM 46, 48 is implemented in multiple components, the SHM 46, 48 may be implemented on a computer system (e.g., a quantum computing system) that includes a plurality of quantum processor devices or classical processor devices of a plurality of different computing devices. Thus, irrespective of the implementation, the examples may be implemented on a computer system that includes one or more processor devices of one or more computing devices. The same is true for any of the quantum services or other services implemented by the first quantum computing device 12 (e.g., the first task manager service 30) or the second quantum computing device 14 (e.g., the second task manager service 40).

In some examples, the SHM 46 may receive the transfer request 44 (e.g., from an operating system associated with the quantum computing system or from a user) to transfer a quantum service from the first quantum computing device 12 to the second quantum computing device 14. For instance, the SHM 46 may receive the transfer request 44 to migrate quantum service 26(4) from the first quantum computing device 12 to the second quantum computing device 14.

In response to the request, the SHM 46 may access a quantum topology service (QTS) 50. The QTS 50 may be implemented by the first quantum computing device 12, the second quantum computing device 14, and/or a different quantum computing device or classical computing device. The QTS 50 may have a quantum hardware map 52 of the quantum computing system 10 and quantum computing devices (e.g., quantum computing device 12 and quantum computing device 14) within the quantum computing system 10. The quantum hardware map 52 may have details regarding parameters of the various quantum computing devices. For instance, the quantum hardware map 52 may have data 54(0) . . . 54(n) indicative of parameters of the various quantum computing devices in the quantum computing system 10, such as the quantum computing device 12 and the quantum computing device 14. Data 54(0) may include, for instance, data indicative of quantum computing device location (e.g., geographic location). Data 54(1) may include, for instance, data indicative of routing information for quantum computing devices in the quantum computing system 10. Data 54(2) may include, for instance, data indicative of local properties and configuration of each quantum computing device in the quantum computing system 10 (e.g., qubit type, number of qubits, temperature profile, error correction scheme, etc.). Data 54(3) may include, for instance, data indicative of services requiring registration (e.g., teleportation services) for each quantum computing device in the quantum computing system 10. The quantum hardware map 52 may include other data 54(n) indicative of parameters of the quantum computing devices in the quantum computing system 10 without deviating from the scope of the present disclosure.

In some examples, the SHM 46 may determine the most appropriate quantum computing device to which to transfer the quantum service 26(4) (e.g., the second quantum computing device 14) within the quantum computing system 10 based on the parameters of the transfer request 44 and/or information associated with the quantum service 26(4). The quantum computing device (e.g., the second quantum computing device 14) determined by the SHM 46 may be, for instance, a quantum computing device with a greater number of local qubits, a quantum computing device with a certain qubit type or having qubits with certain physical properties, a quantum computing device with low error or with a certain error correction scheme, a quantum computing device with more available qubit resources (e.g., a quiet quantum computing device currently using less qubit resources), or a quantum computing device located in a certain geographic location.

After the SHM 46 of the first quantum computing device 12 identifies the second quantum computing device 14 as the destination quantum computing device, the SHM 46 of the first quantum computing device 12 may identify the route to the second quantum computing device 14 over the quantum communication network 16 based at least in part on, for instance, the quantum hardware map 52 of the QTS 50. The SHM 46 of the first quantum computing device 12 may contact the SHM 48 of the second quantum computing device 14 and may provide data indicative of an intent to transfer a quantum service (e.g., quantum service 26(4)) to the second quantum computing device 14. The SHM 46 at the first quantum computing device 12 may contact the first task manager service 30. The SHM 46 of the first quantum computing device 12 may pause the quantum service 26(4) (e.g., using the first task manager service 30). The SHM 46 may coordinate communication of a service replication 56 from the first task manager service 30 to the second task manager service 42. The service replication 56 may include a service identifier 36(0) of the quantum service 26(4) to be transferred. The service replication 56 may include other metadata 32 associated with the quantum service 26(4) to be transferred. In some examples, the first task manager service 30 may set the second task manager service 42 as a destination target of the service replication 56.

Upon receipt of the service replication 56 in the second task manager service 42, the SHM 48 of the second quantum computing device 14 may look for the service identifier 36(0) of the quantum service 26(4) in the second task manager service 42. Upon occurrence of a trigger condition, the second quantum computing device 14 may locate the quantum service definition file (e.g., quantum service definition file 28(4)) associated with the service identifier 36(0) and/or may initiate configuring and/or securing qubits for execution of the quantum service 26(4). The trigger condition may be, for instance, receipt of the service identifier 36(0) in the second task manager service 42 and/or initiation of the quantum service 26(4) based on instructions from the second task manager service 42, scheduler service, operating system, or other service.

In some examples, the transferred quantum service 26(4) may be implemented using the local second qubits 22(0) . . . 22(Q) associated with the second quantum computing device 14 and/or the first qubits 18(0) . . . 18(Q) at the first quantum computing device 12. In some examples, the service 26(4) is implemented using the second qubits 22(0) . . . 22(Q) such that the service is implemented using local quantum states/data in a federated manner.

In some examples, the transferred quantum service 26(4) is implemented at least in part with access to information associated with first qubits 18(0) . . . 18(Q). For instance, the transferred quantum service 26(4) may be implemented at least in part using first qubits 18(0) . . . 18(Q) or using information associated with the first qubits 18(0) . . . 18(Q) in the first qubit registry 20. In this way, the quantum service 26(4) may have access to qubit information prior to transfer of the quantum service 26(4) that may be used to respond to data restoration requests associated with, for instance, partial implementation of the quantum service 26(4) prior to the transfer.

In some examples, the SHM 46 at the second quantum computing device 14 may be configured to modify the quantum service definition file 28(4) associated with the service 26(4). For instance, if the quantum service definition file 28(4) includes instructions associated with a specific qubit type or number of qubits for the first quantum computing device 12, the SHM 46 may modify the quantum service definition file 28(4) to include instructions associated with the specific qubit type or number of qubits for the second quantum computing device 14.

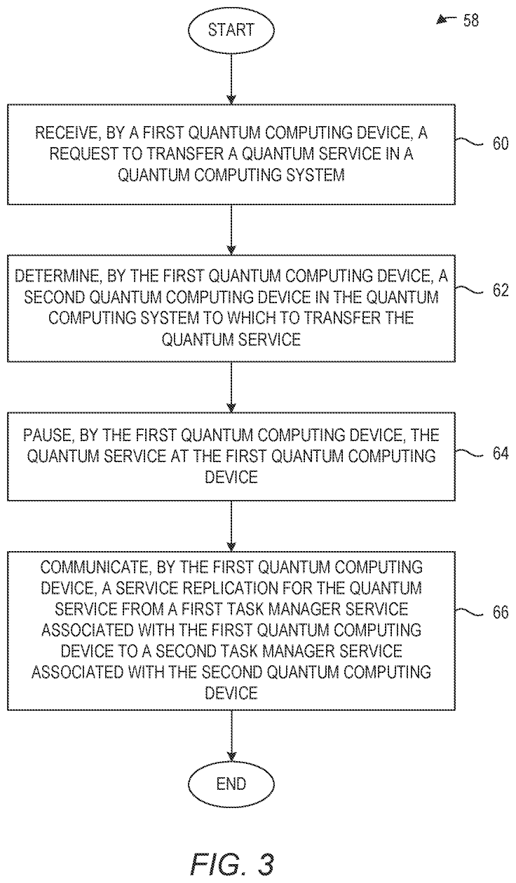

FIG. 3 is a flow chart 58 of an example method according to example implementations of the present disclosure. FIG. 3 may be implemented using one or more quantum computing devices, such as quantum computing device 12 of FIG. 1. Elements of FIG. 1 are referenced in describing FIG. 3 for the sake of clarity. It is to be understood that, in some examples, some operations illustrated in FIG. 3 may be performed in an order other than illustrated herein, include operations not illustrated, and/or may be omitted.

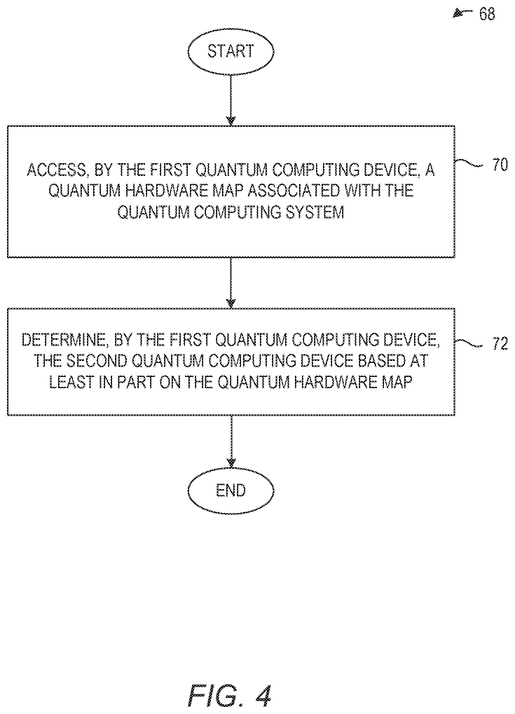

In FIG. 3, the first quantum computing device 12 may receive a request to transfer (e.g., the transfer request 44) a quantum service (e.g., the quantum service 26(4)) in a quantum computing system 10 (Block 60). The first quantum computing device 12 may determine a second quantum computing device 14 in the quantum computing system to which to transfer the quantum service 26(4). (Block 62). In some examples, the first quantum computing device 12 may determine the second quantum computing device based on information in the transfer request 44, such as a specific instruction in the transfer request 44 to transfer the service 26(4) to the second quantum computing device 14. In some examples, the determination may be made using the operations described with reference to FIG. 4.

In FIG. 3, the first quantum computing device 12 may pause the quantum service in the first quantum computing device 12 (Block 64). For instance, the first quantum computing device 12 may pause the quantum service 26(4) in the first task manager service 30. The first quantum computing device 12 may communicate a service replication 56 for the quantum service 26(4) from the first task manager service 30 associated with the first quantum computing device 12 to a second task manager service 42 associated with the second quantum computing device 14 (Block 66).

FIG. 4 is a flow chart 68 of an example method for determining a quantum computing device to which to transfer a quantum service according to example implementations of the present disclosure. FIG. 4 may be implemented using one or more quantum computing devices, such as quantum computing device 12 of FIG. 1. Elements of FIG. 1 are referenced in describing FIG. 4 for the sake of clarity. It is to be understood that, in some examples, some operations illustrated in FIG. 4 may be performed in an order other than illustrated herein, include operations not illustrated, and/or may be omitted.

In FIG. 4, the first quantum computing device 12 may access a quantum hardware map 52 associated with the quantum computing system 10 (Block 70). The quantum hardware map 52 may have details regarding parameters of the various quantum computing devices. For instance, the quantum hardware map 52 may have data 54(0) . . . 54(n) indicative of parameters of the various quantum computing devices in the quantum computing system 10, such as the quantum computing device 12 and the quantum computing device 14. Data 54(0) may include, for instance, data indicative of quantum computing device location (e.g., geographic location). Data 54(1) may include, for instance, data indicative of routing information for quantum computing devices in the quantum computing system 10. Data 54(2) may include, for instance, data indicative of local properties and configuration of each quantum computing device in the quantum computing system 10 (e.g., qubit type, number of qubits, temperature profile, error correction scheme, etc.). Data 54(3) may include, for instance, data indicative of services requiring registration (e.g., teleportation services) for each quantum computing device in the quantum computing system 10. The quantum hardware map 52 may include other data 54(n) indicative of parameters of the quantum computing devices in the quantum computing system 10 without deviating from the scope of the present disclosure.

In FIG. 4, the first quantum computing device 12 may determine the second quantum computing device 14 (e.g., to which to transfer the quantum service 26(4) based at least in part on the quantum hardware map 52 (Block 72). For instance, the first quantum computing device 12 may determine the second quantum computing device 14 based at least in part on the data 54(0) . . . 54(N) indicative of parameters associated with the second quantum computing device 14.

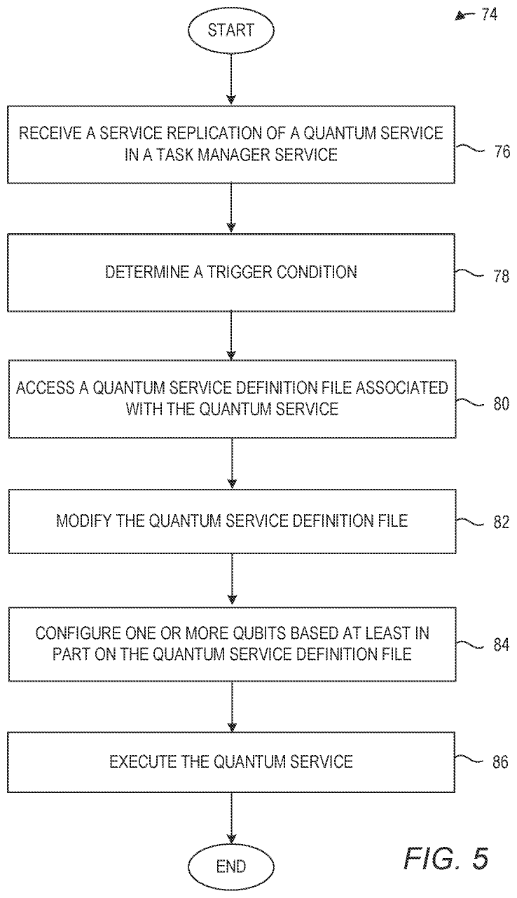

FIG. 5 is a flow chart 74 of an example method according to example implementations of the present disclosure. FIG. 5 may be implemented using one or more quantum computing devices, such as the second quantum computing device 14 of FIG. 1. Elements of FIG. 1 are referenced in describing FIG. 5 for the sake of clarity. It is to be understood that, in some examples, some operations illustrated in FIG. 5 may be performed in an order other than illustrated herein, include operations not illustrated, and/or may be omitted.

In FIG. 5, the second quantum computing device 14 may receive a service replication of the quantum service (e.g., the quantum service 26(4) in a task manager service (e.g., the second task manager service 42) (Block 76). The second quantum computing device 14 may determine a trigger condition. (Block 78). The trigger condition may be associated with initiating configuration and/or securing of qubits to execute the quantum service 26(4). In some example, the trigger condition may include receiving a service identification 36(0) in the second task manager service 42. In some examples, the trigger condition may include initiation of the quantum service 26(4) by the task manager service 42, a scheduler service, an operating system, or a different service.

In FIG. 5, the second quantum computing device 14 may access a quantum service definition file (e.g., the quantum service definition file 28(4)) associated with the quantum service 26(4). (Block 80). For instance, the second quantum computing device 14 may access the QASM repository 29.2 to access the quantum service definition file 28(4).

In some examples, the second quantum computing device 14 may modify the quantum service definition file 28(4) (Block 82). For instance, if the quantum service definition file 28(4) includes instructions associated with a specific qubit type or number of qubits for the first quantum computing device 12, the second quantum computing device 14 may modify the quantum service definition file 28(4) to includes instruction associated with the specific qubit type or number of qubits for the second quantum computing device 14.

In FIG. 5, the second quantum computing device 14 may configure one or more qubits based at least in part on the quantum service definition file 28(4) (Block 84). For instance, the second quantum computing device 14 may configure the local second qubits 22(0) . . . 22(Q) based at least in part on instructions in the quantum service definition file 28(4). The quantum computing device 14 may then execute the quantum service 26(4), for instance, using the second qubits 22(0) . . . 22(Q) (Block 86).

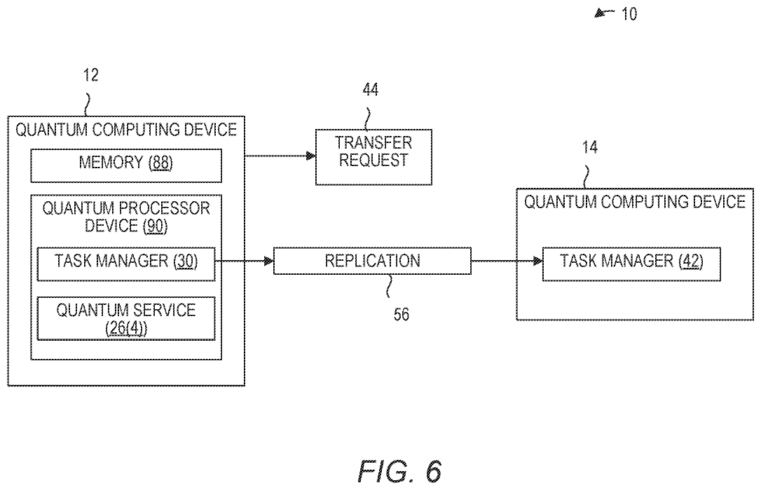

FIG. 6 is a simplified diagram of a quantum computing device 12 according to examples of the present disclosure. The quantum computing device 12 includes a memory 88. The quantum computing device 12 includes a quantum processor device 90 coupled to the memory 88. The quantum processor device 90 is to receive a transfer request 44 to transfer a quantum service 26(4) in a quantum computing system 10. The quantum processor device 90 is to determine a second quantum computing device 14 in the quantum computing system 10 to which to transfer the quantum service 26(4). The quantum processor device 90 is to pause the quantum service 26(4) associated with the first quantum computing device 12. The quantum processor device 90 is to communicate a service replication 56 for the quantum service 26(4) from a first task manager service 30 associated with the first quantum computing device 12 to a second task manager service 42 associated with the second quantum computing device 14.

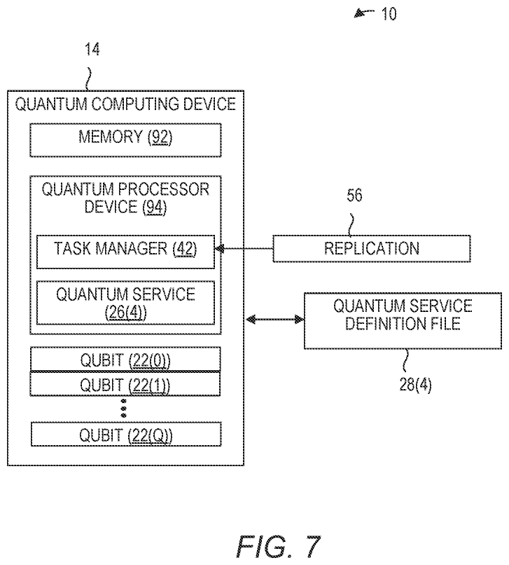

FIG. 7 is a simplified diagram of a quantum computing device 14 according to examples of the present disclosure. The quantum computing device 14 includes a memory 92. The quantum computing device 14 includes a quantum processor device 94 coupled to the memory 92. The quantum processor device 94 is to receive a service replication 56 of a quantum service 26(4) in a task manager service 42 of the quantum computing device 12. The quantum processor device 94 is to access a quantum service definition file 28(4) associated with the quantum service 26(4). The quantum processor device 92 is to configure one or more second qubits 22(0) . . . 22(Q) based at least in part on the quantum service definition file 28(4).

FIG. 8 is a block diagram of a quantum computing device 12, 14 suitable for implementing examples according to example implementations. The quantum computing device 12, 14 may comprise any computing or electronic device capable of including firmware, hardware, and/or executing software instructions to implement the functionality described herein in a quantum environment.

The quantum computing device 12, 14 may include one or more quantum processor device(s) 90, 94, one or more memory device(s) 88, 92 and/or a system bus 96. The system bus 96 provides an interface for system components including, but not limited to, the one or more memory device(s) 88, 92 and the one or more quantum processor device(s) 90, 94. The one or more quantum processor device(s) 90, 94 may be any commercially available or proprietary processor suitable for operating in a quantum environment and may include a combination of quantum processors (e.g., having one or more qubits) and classical processors. The one or more memory device(s) 88, 92 may store computer-readable instructions associated with an operating system 98. The one or more memory device(s) 88, 92 may store computer-readable instructions associated with an SHM 46, 48 and/or task manager service 30, 42. The one or more memory device(s) 88, 92 may store data 100.

The quantum computing device 12, 14 may further include or be coupled to a non-transitory computer-readable storage medium such as a storage device 102. The storage device 102 and other drives associated with computer-readable media and computer-usable media may provide non-volatile storage of data, data structures, computer-executable instructions, and the like. The storage device 102 may also store one or more first qubits 18(0)-18(Q), 22(0)-22(Q) which may be measured and/or manipulated by the one or more quantum processor device(s) 90, 94 when performing quantum computing operations.

All or a portion of the examples may be implemented as a computer program product 104 stored on a transitory or non-transitory computer-usable or computer-readable storage medium, such as the storage device 102, which includes complex programming instructions, such as complex computer-readable program code, to cause the one or more processor devices 90, 94 to carry out the functionality described herein. Thus, the computer-readable program code may comprise software instructions for implementing the functionality of the examples described herein when executed on the one or more processor devices 90, 94.

An operator may also be able to enter one or more configuration commands through a keyboard (not illustrated), a pointing device such as a mouse (not illustrated), or a touch-sensitive surface (not illustrated). The quantum computing device 12, 14 may also include a communications interface 106 suitable for communicating with other computing devices, including, in some implementations, classical computing devices and/or quantum computing devices.

Individuals will recognize improvements and modifications to the preferred examples of the disclosure. All such improvements and modifications are considered within the scope of the concepts disclosed herein and the claims that follow.

1. A method comprising:
receiving, by a first quantum computing device, a request to transfer a quantum service in a quantum computing system;
determining, by the first quantum computing device, a second quantum computing device in the quantum computing system to which to transfer the quantum service;
pausing, by the first quantum computing device, the quantum service associated with the first quantum computing device; and
communicating, by the first quantum computing device, a service replication for the quantum service from a first task manager service associated with a first quantum computing device to a second task manager service associated with the second quantum computing device.

2. The method of claim 1, wherein determining, by the first quantum computing device, a second quantum computing device to which to transfer the quantum service comprises:
accessing, by the first quantum computing device, a quantum hardware map associated with the quantum computing system; and
determining, by the first quantum computing device, the second quantum computing device based at least in part on the quantum hardware map.

3. The method of claim 2, wherein determining the second quantum computing device to which to transfer the quantum service comprises determining, by the first quantum computing device, the second quantum computing device based at least in part on one or more parameters associated with the second quantum computing device specified in the quantum hardware map.

4. The method of claim 3, wherein the one or more parameters comprise one or more of quantum computing device location, a number of qubits, a qubit type, an error correction scheme, or a temperature profile.

5. The method of claim 1, the service replication comprises data indicative of a service identifier associated with the quantum service.

6. The method of claim 5, wherein the service identifier in the second task manager service is a trigger condition for configuration of one or more qubits to execute the quantum service.

7. The method of claim 1, wherein the service replication comprises metadata associated with the quantum service.

8. The method of claim 7, wherein the metadata comprises an identifier of a qubit used by the quantum service, an entanglement status of the qubit used by the quantum service, or a superposition status of the qubit used by the quantum service.

9. The method of claim 1, wherein the method comprises:
accessing, by the second quantum computing device, a quantum service definition file associated with the quantum service; and
configuring, by the second quantum computing device, one or more qubits based at least in part on quantum service definition file.

10. The method of claim 9, wherein the one or more qubits comprise one or more second qubits associated with the second quantum computing device.

11. The method of claim 9, wherein the one or more qubits comprise one or more first qubits associated with the first quantum computing device.

12. The method of claim 9, further comprising modifying the quantum service definition file.

13. The method of claim 1, wherein the quantum service is executed at the second quantum computing device.

14. A quantum computing device, comprising:
a memory; and
a quantum processor device coupled to the memory;
the quantum processor device is to:
receive a service replication of a quantum service in a task manager service of the quantum computing device;
access a quantum service definition file associated with the quantum service; and
configure one or more qubits based at least in part on the quantum service definition file.

15. The quantum computing device of claim 14, wherein the quantum processor device is to execute the quantum service.

16. The quantum computing device of claim 14, wherein the service replication comprises a service identifier.

17. The quantum computing device of claim 16, wherein the quantum processor device is further to determine a trigger condition based on the service identifier in the service replication, wherein the quantum processor device is to configure one or more qubits based at least in part on the quantum service definition file upon occurrence of the trigger condition.

18. The quantum computing device of claim 14, wherein the quantum processor device is to modify the quantum service definition file.

19. A non-transitory computer-readable storage medium comprises instructions to cause one or more processor devices, on a first quantum computing device that implements a plurality of qubits, to:
determine a second quantum computing device in a quantum computing system to which to transfer a quantum service;
pause the quantum service in a first task manager service associated with the first quantum computing device; and
communicate a service replication for the quantum service from a first task manager service associated with a first quantum computing device to a second task manager service associated with the second quantum computing device.

20. The non-transitory computer-readable storage medium of claim 19, wherein the first quantum computing device is to:
access a quantum hardware map associated with the quantum computing system; and
determine the second quantum computing device based at least in part on the quantum hardware map.
